(19) United States
(12) Patent Application Publication
(10) Pub. No.: US 2012/0166428 A1
(43) Pub. Date: Jun. 28, 2012

(54) METHOD AND SYSTEM FOR IMPROVING QUALITY OF WEB CONTENT

(75) Inventors: Vinay KAKADE, Sunnyvale, CA (US); Raghu RAMAKRISHNAN, Santa Clara, CA (US); Cong YU, Hoboken, NJ (US)

(73) Assignee: Yahoo! Inc, Sunnyvale, CA (US)

(21) Appl. No.: 12/975,389

(22) Filed: Dec. 22, 2010

(51) Int. Cl. G06F 17/30

(52) U.S. Cl. 707/723; 707/E17.014

(57) ABSTRACT

A method of improving quality of web content. The method includes analyzing search logs associated with a plurality of web pages by a processor. The search logs are stored in an electronic storage device. A plurality of queries from the search logs are assembled into one or more query profiles. Concepts for the one or more query profiles are generated and classified into one or more concept profiles. Further, the one or more concept profiles are ranked based on one or more parameters. The one or more concept profiles are then transmitted to one or more mediums.

### BACKGROUND

Usually, web content is used for satisfying queries on the web. However, a number of queries on the web are unsatisfied due to lack of quality content and ranking of search results. Identifying and amending such web content is desired. Further, there is a need to improve the ranking of the search results.

### SUMMARY

An example of a method of improving quality of web content includes analyzing search logs associated with a plurality of web pages by a processor. The search logs are stored in an electronic storage device. The method also includes assembling a plurality of queries from the search logs into one or more query profiles and generating concepts for the one or more query profiles. The method further includes classifying the concepts into one or more concept profiles. Further, the method includes ranking the one or more concept profiles based on one or more parameters. Moreover, the method includes transmitting the one or more concept profiles to one or more mediums.

An example of an article of manufacture includes a machine readable medium and instructions carried by the machine readable medium and operable to cause a programmable processor to perform analyzing search logs associated with a plurality of web pages and assembling a plurality of queries from the search logs into one or more query profiles. The article of manufacture also includes instructions carried by the machine readable medium and operable to cause the programmable processor to perform generating concepts for the one or more query profiles and classifying the concepts into one or more concept profile. The article of manufacture also includes instructions carried by the machine readable medium and operable to cause the programmable processor to perform ranking the one or more concept profiles based on one or more parameters. The article of manufacture further includes instructions carried by the machine readable medium and operable to cause the programmable processor to perform transmitting the one or more concept profiles to one or more mediums.

An example of a system for improving quality of web content includes an electronic device, a communication interface in electronic communication with one or more web servers comprising multiple web pages and with the electronic device, a memory that stores instructions and a processor responsive to the instructions to analyze search logs associated with a plurality of web pages. The processor also assembles a plurality of queries from the search logs into one or more query profiles and generates concepts for the one or more query profiles. The processor is further responsive to the instructions to classify the concepts into one or more concept profiles and rank the one or more concept profiles based on one or more parameters. The processor is further responsive to the instructions to transmit the one or more concept profiles to one or more mediums. The system also includes an electronic storage device that stores the search logs.

### BRIEF DESCRIPTION OF THE FIGURES

FIG. 1 is a block diagram of an environment, in accordance with which various embodiments can be implemented;

FIG. 2 is a block diagram of a server, in accordance with one embodiment; and

FIG. 3 is a flowchart illustrating a method for improving quality of web content, in accordance with one embodiment.

### DETAILED DESCRIPTION OF THE EMBODIMENTS

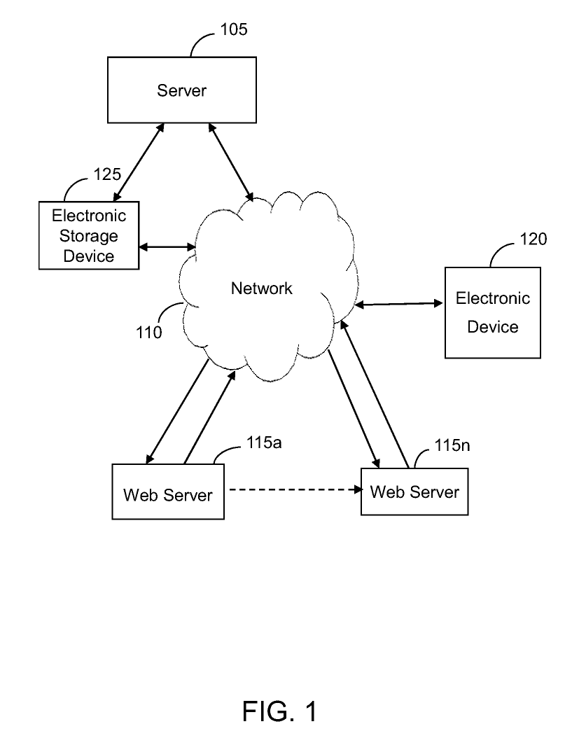

FIG. 1 is a block diagram of an environment 100, in accordance with which various embodiments can be implemented. The environment 100 includes a server 105 connected to a network 110. The server 105 is in electronic communication through the network 100 with one or more web servers, for example a web server 115a and a web server 115n. The web servers can be located remotely with respect to the server 105. Each web server can host one or more websites on the network 110. Each website can have multiple web pages. Examples of the network 110 include, but are not limited to, a Local Area Network (LAN), a Wireless Local Area Network (WLAN), a Wide Area Network (WAN), internet, and a Small Area Network (SAN).

The server 105 is also in communication with an electronic device 120 of a user via the network 110 or directly (not shown). The electronic device 120 can be remotely located with respect to the server 105. Examples of the electronic device 120 include, but are not limited to, computers, laptops, mobile devices, hand held devices, telecommunication devices and personal digital assistants (PDAs).

In some embodiments, the server 105 can perform functions of the electronic device 120.

The server 105 has access to the web sites hosted by the web servers, for example the web server 115a and the web server 115n. The server 105 processes the web pages to analyze a plurality of queries.

The server 105 is also connected to an electronic storage device 125 directly or via the network 110 to store information, for example search logs, and the queries and concepts associated with the search logs.

In some embodiments, different electronic storage devices are used for storing the information. Also, improvement of web content can be performed using multiple servers.

The user of the electronic device 120 accesses a web page, for example Yahoo!®, via the electronic device 120 and enters a query in a search engine, for example Yahoo!® Web Search. The query for a particular subject, for example a job, is communicated to the server 105 through the network 110 by the electronic device 120 in response to the user inputting the query. The server 105 communicates contents to the user based on the query in the form of search logs. In this manner multiple search logs, associated with a plurality of web pages, are stored in the electronic storage device 125. The search logs are then analyzed by the server 105 to assemble a plurality of queries into one or more query profiles. The queries can be defined as the queries that are unsatisfied on the web. The server 105 then generates concepts for the query profiles. The concepts are classified into one or more concept profiles and further ranked based on one or more parameters. The server 105 can further transmit the concept profiles to one or more mediums, for example web interfaces and daily feeds.

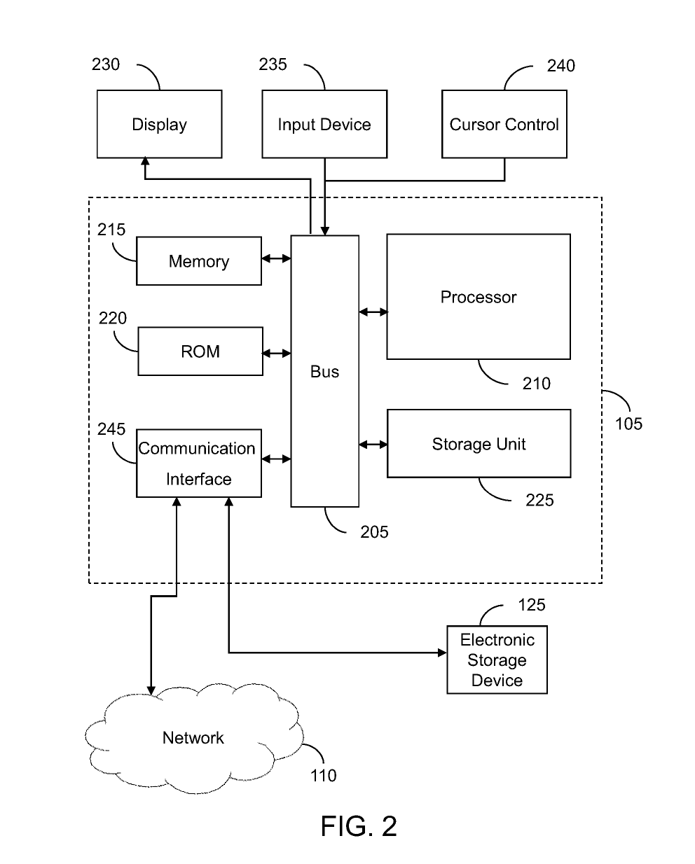

The server 105 includes a plurality of elements for providing the contents. The server 105 including the elements is explained in detail in FIG. 2.

FIG. 2 is a block diagram of the server 105, in accordance with one embodiment. The server 105 includes a bus 205 or other communication mechanism for communicating information, and a processor 210 coupled with the bus 205 for processing information. The server 105 also includes a memory 215, such as a random access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The server 105 further includes a read only memory (ROM) 220 or other static storage device coupled to bus 205 for storing static information and instructions for processor 210. A storage unit 225, such as a magnetic disk or optical disk, is provided and coupled to the bus 205 for storing information, for example search logs and a plurality of queries.

The server 105 can be coupled via the bus 205 to a display 230, such as a cathode ray tube (CRT), and liquid crystal display (LCD) for displaying information to the user. An input device 235, including alphanumeric and other keys, is coupled to bus 205 for communicating information and command selections to the processor 210. Another type of user input device is a cursor control 240, such as a mouse, a trackball, or cursor direction keys for communicating direction information and command selections to the processor 210 and for controlling cursor movement on the display 230. The input device 235 can also be included in the display 230, for example a touch screen.

Various embodiments are related to the use of server 105 for implementing the techniques described herein. In some embodiments, the techniques are performed by the server 105 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, such as storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to an electronic storage device 125 to store information associated with search logs.

In some embodiments, the server 105 receives a plurality of queries as input. The server 105 then generates the search logs associated with the queries. The server 105 can then store the search logs and later analyze the search logs in order to assemble the queries into one or more query profiles. The server 105 generates concepts for the query profiles. The server 105 classifies the concepts into one or more concept profiles and ranks the concepts based on one or more parameters. The server 105 can further transmit the concept profiles to one or more mediums, for example web interfaces and daily feeds.

In some embodiments, the server 105 directly assembles the queries into the concept profiles.

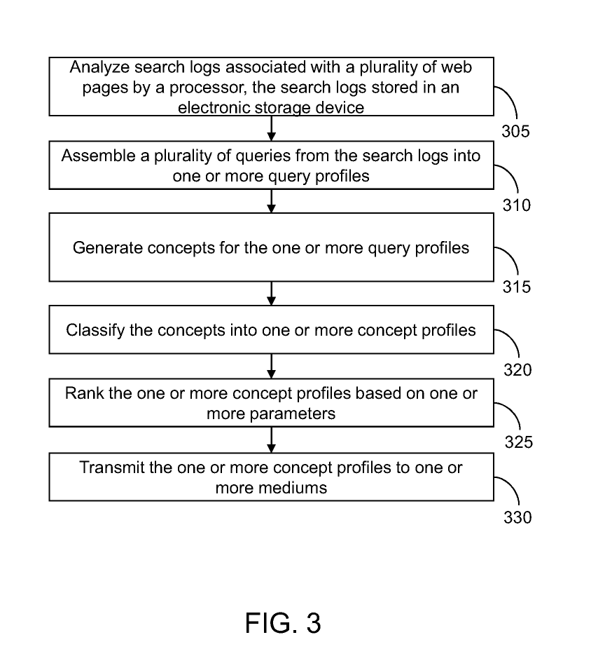

FIG. 3 is a flowchart illustrating a method for improving quality of web content.

At step 305, the search logs associated with a plurality of web pages are analyzed. The search logs can include text, images and links. The search logs can be analyzed using a platform, for example a log business intelligence (log BI) platform or a contextual analysis platform (CAP). The search logs are analyzed to check and extract a plurality of queries based on a frequency factor. The queries can be extracted using a filter, for example a heuristic filter.

In some embodiments, visit logs associated with the web pages are also analyzed to extract the queries.

At step 310, the queries from the search logs are assembled into one or more query profiles. A query profile includes metadata for a particular query. In one example, for a query ‘tiger woods’, the query profile can include, but is not limited to, a number of times the query was entered in a search engine over a time period, for example a day, a week or a month, a number of users who entered the query, various queries made before and after the query, top uniform resource locators (URLs) clicked for the query and the time spent on each of the top URLs clicked by the user.

At step 315, concepts are generated for the one or more query profiles. A concept can be defined as a set of queries that are similar to each other. The concept can be a single word, an idiom, a restricted collocation or a free combination of words. For example, if a user enters a query ‘new york times subscription’, the concepts that are generated can include ‘new york times’ and ‘subscription’. The concepts are generated for the query profile using a probabilistic model, for example an n-gram model. The n-gram model can be defined as a probabilistic model that can be used for predicting a next query in a sequence of queries. The n-gram model can be used in various applications, for example natural language processing, speech recognition and speech tagging.

An n-gram is a sequence of n contiguous words, where the length of the sequence is n number of words. For example, a four-gram is a sequence of four contiguous words. The n-gram can also be defined as a subsequence of n queries from the given sequence of queries. Examples of the queries can include, but are not limited to, phonemes, syllables, letters and words.

N-grams in the query are gathered using the n-gram model. Frequently searched n-grams are further stored in an electronic storage device, for example the electronic storage device 125. A dominant n-gram is determined when frequency of the n-gram is above a certain threshold. The dominant n-gram is utilized for concept generation.

The n-grams are acquired with an upper limit on length of sequence of words entered by the user, for example, n=[1,k], where k represents the upper limit. For a query ‘tiger woods scandal’, 1-grams can be tiger, woods or scandal, 2-grams can be tiger woods or woods scandal, and 3-grams can be tiger woods scandal. The n-grams acquired for the query is represented by a parameter ‘g’. For each n-gram g, a relative frequency is calculated. The relative frequency of the n-gram g, is compared with a prefix (n−1)-gram and a suffix (n−1)-gram of the n-gram g. For example, let n-gram g=‘tiger woods scandal’, the prefix 2-gram can be represented as g_f=tiger woods and the suffix 2-gram can be represented as g_s=“woods scandal”, then conf_f(g)=freq(g)/freq(g_f) and conf_s(g)=freq(g)/freq(g_s) are calculated.

The dominant n-gram is then determined by calculating an average frequency, a relative frequency, and a maximum frequency as follows:

Avg(Conf_{—}f(g),Conf_{—}s(g))>=threshold1

Rel_Conf(g)>=threshold2

Max(Conf_{—}f,Conf_{—}s)/Min(Conf_{—}f,Conf_{—}s)>threshold3

In some embodiments, the concepts can also be generated using a model based on machine learning. Each concept involves semantic information of the query entered by a user in a machine learning process. The concepts can also be generated using part-of-speech (POS) tagging. POS tagging can also be referred to as grammatical tagging or word category disambiguation. POS tagging can be defined as a process of marking a plurality of words constituting a text that corresponds to a particular part-of-speech, based on one of definition, context comprising relationship with adjacent words, related words in a phrase, related words in a sentence and related words in a paragraph.

At step 320, the concepts are classified into one or more concept profiles. Each concept profile includes one or more concepts.

In some embodiments, the concept profiles can be generated by analyzing the search logs using the log BI platform.

At step 325, the one or more concept profiles are ranked based on one or more parameters. Examples of the parameters include, but are not limited to, popularity of the query, trending for the query, a click parameter of the query and a puzzling parameter of the query.

The popularity of the query can be determined by evaluating frequency of the query that is entered by a plurality of users. The frequency of the query can be defined as number of entries of the query in a given period of time. The popularity can be determined by evaluating a buzz index. The buzz index can also be referred to as spiking. The buzz index can be defined as a percentage of the users searching for a specific query. The percentage of the users can be determined over a predetermined period of time, for example a day, a week or a month.

The trending for the query is a form of comparative analysis. The trending is employed to identify current queries and future queries. The trending can be determined using equation (1) given below:

$${S}_{trend} = \frac{\vert {C}_{last} \vert - mean}{standard deviation} \times {log}_{e} {log}_{e} ( \vert {C}_{total} \vert ) \qquad ( 1 )$$

where Cₗₐₛₜ represents number of click counts for a particular query on a day, mean represents the number of click counts for a particular query over a week and Cₜₒₜₐₗ represents total number of queries present in the web.

The click parameter of the query can be defined as number of search results that are clicked or accessed by different users for the particular query. The queries having increased click parameter can be regarded as queries that require editing. The click parameter facilitates in determining satisfaction of a particular query by the user. The click parameter can be determined using a equation (2) given below:

$$\frac{\vert {C}_{last} - mean \vert}{standard deviation} \times \frac{{C}_{total} - {C}_{top \text{-} 3}}{{C}_{total}} \times {log}_{e} ( min ( \vert {C}_{total} \vert , 10000 ) ) \qquad ( 2 )$$

where Cₜₒₚ₋₃ can be regarded as the number of click counts on a top three uniform resource locators (URL's) for the query.

The puzzling parameter of the query can be defined as a parameter that determines if the users have been able to find appropriate search results for the query or are puzzled even after clicking on multiple search results. The puzzling parameter of the query facilitates capturing of the queries having increased click parameter. The puzzling parameter can be determined for various queries, for example news, direct display (DD) concepts and single query dominated concepts. The puzzling parameter also enables detection of websites that include the queries, based on a manual dictionary. The manual dictionary is defined as an electronically collected set of data describing definition, structure and administration of the queries. The puzzling parameter can be calculated based on user satisfaction and analyzing a click count for the query. The click count is analyzed based on non-organic clicks, for example DD clicks, ad clicks and navigation clicks.

Concept generation for the queries and subsequent ranking can also be performed with respect to a particular geographical area. In one example, the concept generation and ranking is performed for the queries that only originated from Colorado. An algorithm responsible for the concept generation and the ranking can be utilized for generating a local-trending-now module that is relevant to the particular geographical area. The local-trending-now module indicates current trends at the particular geographical area. The local-trending-now module indicating the current trends at the particular geographical area can be displayed on a home page of a website. In one example, a local-trending-now module for Sunnyvale has concepts that are trending in Sunnyvale.

At step 330, the concept profiles are transmitted to one or more mediums. The concepts that are generated based on ranking of the concept profiles can be displayed to the user via the mediums, for example a web interface, daily feeds and application programming interface (API) accesses. The web interface is a user interface where interaction between the user and system occurs. Examples of the user interface include, but are not limited to, a graphical user interface (GUI), a web based user interface (WUI), a command line interface, a touch user interface and an object oriented user interface. The API accesses provide an interface between the user and the system. The API accesses have various advantages that include speed, reliability and extensibility. The concepts that are interesting to the user can hence be displayed to the user through the API accesses.

In some embodiments, the ranked concept profiles can be edited by an editor before being transmitted to the mediums. The editor can create the content such that the query is satisfied by the user. The generated concept profile corresponding to the query can be further used to change the query entered by the user in order to get additional content.

Identification of the concepts that are unsatisfied on the web and subsequent ranking enables improvement of web content. The web content can be improved by providing shortcuts or DD modules for such concepts, or by creating content for such concepts. Further, by creating a local-trending-now module for a particular geographical area, concepts that are trending in that particular area can be displayed.

While exemplary embodiments of the present disclosure have been disclosed, the present disclosure may be practiced in other ways. Various modifications and enhancements may be made without departing from the scope of the present disclosure. The present disclosure is to be limited only by the claims.

What is claimed is:

1. A method of improving quality of web content, the method comprising:
analyzing search logs associated with a plurality of web pages by a processor, the search logs stored in an electronic storage device;
assembling a plurality of queries from the search logs into one or more query profiles;
generating concepts for the one or more query profiles;
classifying the concepts into one or more concept profiles;
ranking the one or more concept profiles based on one or more parameters; and
transmitting the one or more concept profiles to one or more mediums.

2. The method as claimed in claim 1 and further comprising:
receiving a query from a user;
modifying the search query, in the processor, according to the one or more concept profiles in the electronic storage device;
executing the modified search query; and
providing improved quality of the web content to the user based on the execution.

3. The method as claimed in claim 1, wherein analyzing the search logs comprises:
checking the plurality of queries based on a frequency factor.

4. The method as claimed in claim 1 and further comprising:
assembling the plurality of queries from the search logs into the one or more concept profiles.

5. The method as claimed in claim 1, wherein generating the concepts comprises:
generating one or more n-grams based on the concepts; and
classifying the one or more n-grams.

6. The method as claimed in claim 1, wherein ranking the one or more concept profiles based on the one or more parameters comprises:
estimating popularity of the query;
estimating trending for the query;
estimating a click parameter of the query; and
estimating a puzzling parameter of the query.

7. The method as claimed in claim 6, wherein estimating the popularity of the query comprises
determining frequency of the query.

8. The method as claimed in claim 6, wherein estimating the puzzling parameter of the query comprises:
determining user satisfaction for the query; and
analyzing a click count for the query.

9. An article of manufacture comprising:
a machine readable medium; and
instructions carried by the machine readable medium and operable to cause a programmable processor to perform:
analyzing search logs associated with a plurality of web pages by a processor, the search logs stored in an electronic storage device;
assembling a plurality of queries from the search logs into one or more query profiles;
generating concepts for the one or more query profiles;
classifying the concepts into one or more concept profiles;
ranking the one or more concept profiles based on one or more parameters; and
transmitting the one or more concept profiles to one or more mediums.

10. The article of manufacture as claimed in claim 9 and further comprising instructions operable to cause the programmable processor to perform:
receiving a query from a user;
modifying the search query, in the processor, according to the one or more concept profiles in the electronic storage device;
executing the modified search query; and
providing improved quality of the web content to the user based on the execution.

11. The article of manufacture as claimed in claim 9, wherein analyzing the search logs comprises:
checking the plurality of queries based on a frequency factor.

12. The article of manufacture as claimed in claim 9 and further comprising instructions operable to cause the programmable processor to perform:
assembling the plurality of queries from the search logs into the one or more concept profiles.

13. The article of manufacture as claimed in claim 9, wherein generating the concepts comprises:
generating one or more n-grams based on the concepts; and
classifying the one or more n-grams.

14. The article of manufacture as claimed in claim 9, wherein ranking the one or more concept profiles based on the one or more parameters comprises:
estimating popularity of the query;
estimating trending for the query;
estimating a click parameter of the query; and
estimating a puzzling parameter of the query.

15. The article of manufacture as claimed in claim 14, wherein the popularity of the query comprises
determining frequency of the query.

16. The article of manufacture as claimed in claim 14, wherein estimating the puzzling parameter of the query comprises:
determining user satisfaction for the query; and
analyzing a click count for the query.

17. A system for improving quality of web content, the system comprising:
an electronic device;
a communication interface in electronic communication with one or more web servers comprising multiple web pages and with the electronic device;
a memory that stores instructions; and
a processor responsive to the instructions to
analyze search logs associated with a plurality of web pages;
assemble a plurality of queries from the search logs into one or more query profiles;
generate concepts for the one or more query profiles;
classify the concepts into one or more concept profiles;
rank the one or more concept profiles based on one or more parameters; and
transmit the one or more concept profiles to one or more mediums; and
an electronic storage device that stores the search logs.

18. The system as claimed in claim 17, wherein the processor is further responsive to the instructions to:
assemble the plurality of queries from the search logs into the one or more concept profiles.
